(19) United States
(12) Patent Application Publication
(10) Pub. No.: US 2026/0039054 A1
(43) Pub. Date: Feb. 5, 2026

(54) BOLT POSITION ASSURANCE DEVICE FOR A POWER HARNESS CONNECTOR

(71) Applicant: TE Connectivity Solutions GmbH, Schaffhausen (CH)

(72) Inventor: Aric J. Boyer, Troy, MI (US)

(21) Appl. No.: 18/976,972

(22) Filed: Dec. 11, 2024

Related U.S. Application Data
(60) Provisional application No. 63/678,190, filed on Aug. 1, 2024.

(51) Int. Cl. H01R 13/621; H01R 13/52; H01R 13/641

(52) U.S. Cl. CPC H01R 13/621; H01R 13/5219; H01R 13/641; H01R 2201/26

(57) ABSTRACT

A power harness connector includes a housing having a chamber and a hub with a bore passing through the housing. The power harness connector includes a power contact received in the chamber and a power conductor extending from the power contact and the housing. The power harness connector includes a threaded bolt received in the hub and passing through the bore and through an opening in the power contact configured for threadably coupling to a mating threaded connector of the mating harness connector. The power harness connector includes a bolt position assurance device coupled to the hub and movable between a pre-stage position and an assurance position. The bolt position assurance device assures positioning of the threaded bolt in the hub, to a tightened position, when in the assurance position.

### CROSS REFERENCE TO RELATED APPLICATIONS

This application claims benefit to U.S. Application No. 63/678,190, filed 1 Aug. 2024, the subject matter of which is herein incorporated by reference in its entirety.

### BACKGROUND OF THE INVENTION

The subject matter herein relates generally to power connectors.

Power connectors are used to electrically connect various electrical components, such as to deliver power from one component to another component. For example, in an electric vehicle, power connectors may be used to electrically connect the battery of the vehicle with another component, such as an electric motor of the vehicle. Some known systems use power cables or busbars for high voltage power transmission. However, connection between the power cables may be difficult. For example, when used in electric vehicles, the connection is susceptible to vibration and deterioration from the environment, such as moisture or debris. Additionally, the connectors include many parts, making assembly time consuming with potential to misplace or lose components during assembly or mating. Some power connectors may be connected by a bolted connection. The bolt needs to be tightened to a predetermined torque for proper connection. Under-tightening may lead to a bad connection or may lead to untightening of the bolt over time, such as due to vibration.

A need remains for a robust and reliable power connector system, such as for electric vehicles.

### BRIEF DESCRIPTION OF THE INVENTION

In one embodiment, a power harness connector is provided and includes a housing that has a chamber extending between a terminating end and a mating end configured to be mated with a mating harness connector. The housing includes a hub at the mating end with a bore passing through the housing. The power harness connector includes a power conductor extending from the chamber at the terminating end. The power harness connector includes a power contact received in the chamber. The power contact has a terminating end terminated to the power conductor and a mating end aligned with the bore at the mating end of the housing. The power contact includes a base plate having an opening. The power harness connector includes a threaded bolt received in the hub and passing through the bore. The threaded bolt passes through the opening. The threaded bolt configured to be threadably coupled to a mating threaded connector of the mating harness connector to a tightened position. The power harness connector includes a bolt position assurance device coupled to the hub and movable between a pre-stage position and an assurance position. The bolt position assurance device assures positioning of the threaded bolt in the hub at the tightened position in the assurance position.

In another embodiment, a power harness connector is provided and includes a housing that has a chamber extending between a terminating end and a mating end configured to be mated with a mating harness connector. The housing includes a hub at the mating end with a bore passing through the housing. The power harness connector includes a power conductor extending from the chamber at the terminating end. The power harness connector includes a power contact received in the chamber. The power contact has a terminating end terminated to the power conductor and a mating end aligned with the bore at the mating end of the housing. The power contact includes a base plate having an opening. The power harness connector includes a threaded bolt received in the hub and passes through the bore. The threaded bolt passes through the opening. The threaded bolt configured to be threadably coupled to a mating threaded connector of the mating harness connector. The threaded bolt is rotated between an untightened position and a tightened position. The threaded bolt is tightened to a predetermined torque at the tightened position. The power harness connector includes a bolt position assurance device coupled to the hub and movable between a pre-stage position and an assurance position. The bolt position assurance device is only able to move to the assurance position when the threaded bolt is in the tightened position. The bolt position assurance device assures positioning of the threaded bolt in the hub at the tightened position in the assurance position.

In a further embodiment, a power harness is provided and includes a first harness connector that includes a first housing having a first hub with a first bore passes through the first housing. The first harness connector includes a first power conductor. The first harness connector includes a first seal sealed to the first housing. The first harness connector includes a threaded bolt received in the first hub and passes through the first bore. The threaded bolt includes an insulating cover covering a head and an insulating cap at a distal end of a threaded shaft. The first harness connector includes a bolt seal sealed between the threaded bolt and the first housing. The first harness connector includes a first power contact received in the first hub. The first power contact has a terminating end terminated to the first power conductor and a mating end aligned with the first bore. The first power contact includes a first base plate that has a first opening receiving the threaded shaft of the threaded bolt. The power harness includes a second harness connector coupled to the first harness connector. The second harness connector includes a second housing that has a second hub with a second bore passes through the second housing. The second harness connector includes a second power conductor. The second harness connector includes a second seal sealed to the second housing. The second harness connector includes a socket insert received in the second hub and passes through the second bore. The socket insert includes a threaded bore threadably coupled to the threaded bolt of the first harness connector. The socket insert includes an insulating cap at a distal end of socket insert. The second harness connector includes a second power contact has a terminating end terminated to the second power conductor and a mating end aligned with the second bore. The second power contact includes a second base plate has a second opening receiving the threaded insert. The power harness includes a mating seal sealed between the first housing and the second housing at a mating interface between the first and second harness connectors. The power harness includes a bolt position assurance device coupled to the first hub and movable between a pre-stage position and an assurance position. The threaded bolt is threadably coupled to the threaded insert to a tightened position. The bolt position assurance device assures positioning of the threaded bolt in the first hub at the tightened position in the assurance position.

### BRIEF DESCRIPTION OF THE DRAWINGS

FIG. 1 is a top perspective view of a power system having a power harness in accordance with an exemplary embodiment showing components in an assembled state.

FIG. 2 is a top perspective view of the power system showing components of the power harness in a pre-assembled state and poised for coupling together in accordance with an exemplary embodiment.

FIG. 3 is a cross-sectional view of the power harness in accordance with an exemplary embodiment.

FIG. 4 is a cross-sectional view of the power system showing the first harness connector initially mated with the second harness connector in a pre-stage position showing the threaded connectors unmated.

FIG. 5 is a cross-sectional view of the power system showing the first harness connector mated with the second harness connector showing the threaded connectors in a mated condition and showing the bolt position assurance device in a pre-stage position in accordance with an exemplary embodiment.

FIG. 6 is a cross-sectional view of the power system showing the first harness connector mated with the second harness connector showing the threaded connectors in the mated condition and showing the bolt position assurance device in an assurance position in accordance with an exemplary embodiment.

### DETAILED DESCRIPTION OF THE INVENTION

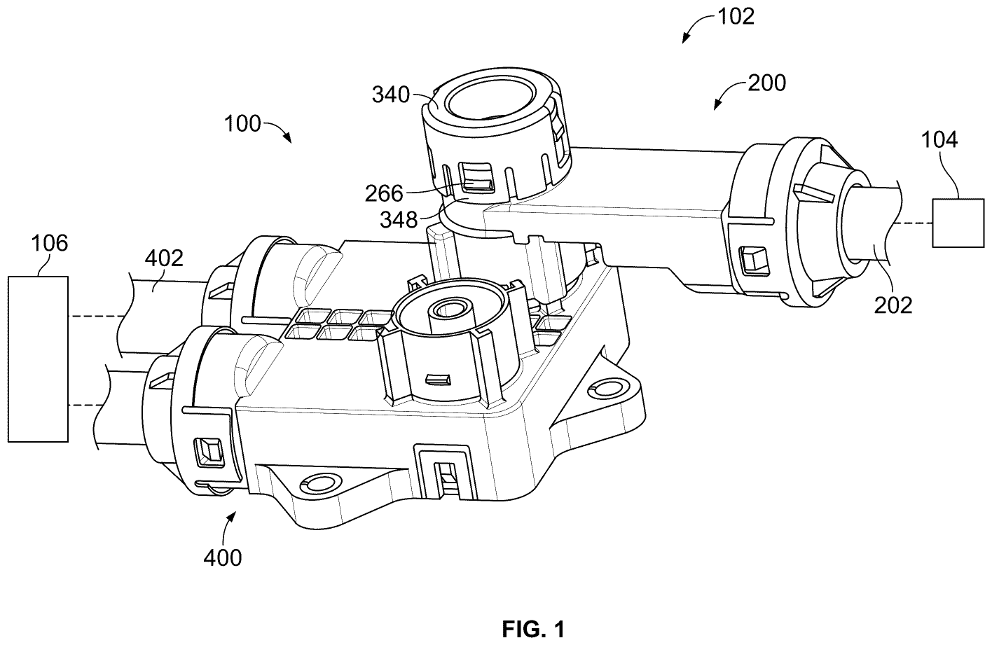

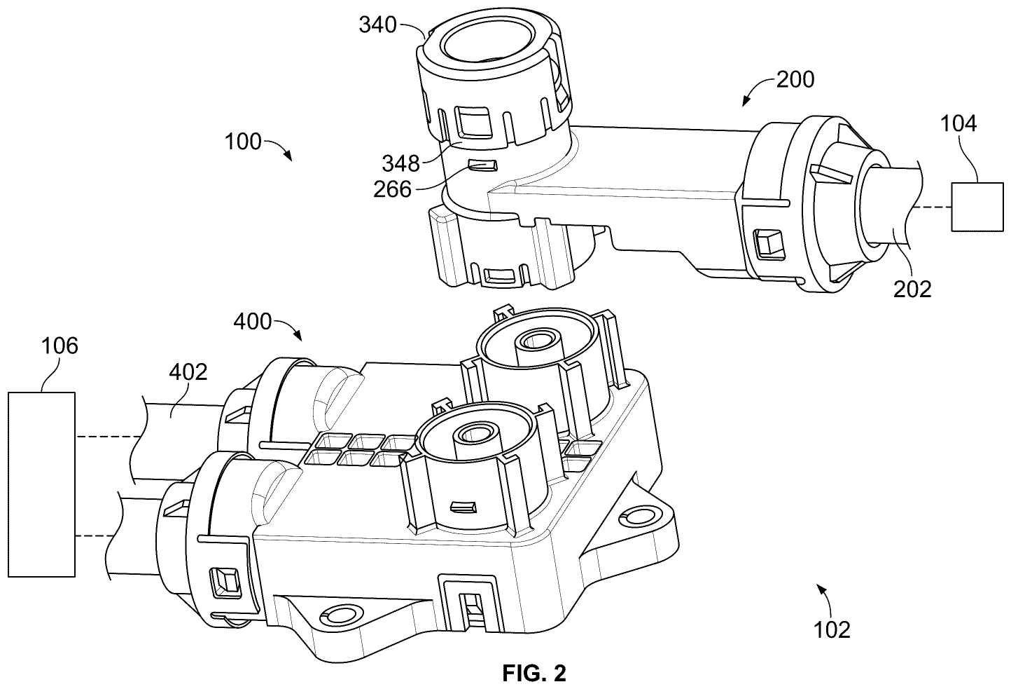

FIG. 1 is a top perspective view of a power system 100 having a power harness 102 in accordance with an exemplary embodiment showing components in an assembled state. FIG. 2 is a top perspective view of the power system 100 showing components of the power harness in a pre-assembled state and poised for coupling together. The power harness 102 includes power connectors used to electrically connect a first component 104 and a second component 106. For example, the power harness 102 includes a first harness connector 200 and a second harness connector 400.

The first harness connector 200 is a cable connector provided at an end of one or more power cables 202 (for example, two power cables 202 in the illustrated embodiment). The second harness connector 400 may additionally or alternatively be provided at an end of a power cable (not shown). For example, the second harness connector 400 may be a cable connector provided at an end of one or more power cables 402 (for example, two power cables 402 in the illustrated embodiment). The second harness connector 400 may be connected to a different type of power conductor in alternative embodiments, such as to a busbar or a power terminal, such as associated with the second component 106.

In the illustrated embodiment, the second harness connector 400 is a header connector configured to be mounted to a component, such as directly to the electrical component 106 or to a chassis, a frame, a wall, a panel, or other supporting structure. The first harness connector 200 is a plug connector configured to be plugged onto the second harness connector 400 (for example, header connector) to electrically connect the components 104, 106. The harness connectors 200, 400 provide a separable interface in a power transmission line between the first and second components 104, 106.

In various embodiments, the power system 100 may be part of a vehicle, such as an electric vehicle. The first component 104 may be a battery of the vehicle and the second component 106 may be a powered device of the vehicle, such as an inverter or motor of the vehicle or a vehicle subsystem, such as a charging inlet, a heater, a compressor, or another vehicle subsystem. The power system 100 may be used in other applications other than electric vehicles in alternative embodiments.

In an exemplary embodiment, the first and second harness connectors 200, 400 are mechanically connected using threaded components, such as a threaded bolt received in a threaded insert, to connect the first and second harness connectors 200, 400. In an exemplary embodiment, the harness connectors 200, 400 are compact or low profile, such as occupying not much more space (for example, height and/or width and/or length) than the corresponding power cable(s) 202.

In an exemplary embodiment, the harness connectors 200, 400 are sealed connectors forming a sealed interface therebetween. The first harness connector 200 is sealed to the power cable 202. The second harness connector 400 may be sealed to the power cable 402. The second harness connector 400 may be sealed to the mounting structure, such as to the component 106. The harness connectors 200, 400 are sealed to each other using an environmental seal at the mating interface. The threaded fasteners may additionally be sealed within the harness connectors 200, 400.

In an exemplary embodiment, the harness connectors 200, 400 are touch safe, wherein any and all live conductive elements are insulated to prevent short circuiting, sparking, arcing or injury from touching the live element. The harness connectors 200, 400 are touch safe both in the mated conditions and the unmated condition.

In an exemplary embodiment, the harness connectors 200, 400 are vibration resistant to maintain a reliable electrical connection along the power transmission line. For example, the first harness connector 200 and/or the second harness connector 400 may include a position assurance device for the corresponding threaded connector. For example, the first harness connector 200 may include a bolt position assurance device 340 configured to provide positional assurance of the threaded bolt (for example, assurance that the bolt is in a tightened position). The bolt position assurance device 340 may be configured to assure that the bolt is at a predetermined torque. For example, the bolt position assurance device 340 may be movable to an assurance position only when the threaded bolt is in a predetermined position corresponding to a predetermined torque (for example, tightened down a predetermined amount relative to the mating threaded insert).

In an exemplary embodiment, the harness connectors 200, 400 may be mated at various orientations relative to each other. For example, the power cables 202 may extend away from the connection at different angles, such as 180°, 90° or at other angles. While a single interface is illustrated in FIGS. 1 and 2, the harness connectors 200, 400 may have multiple interfaces.

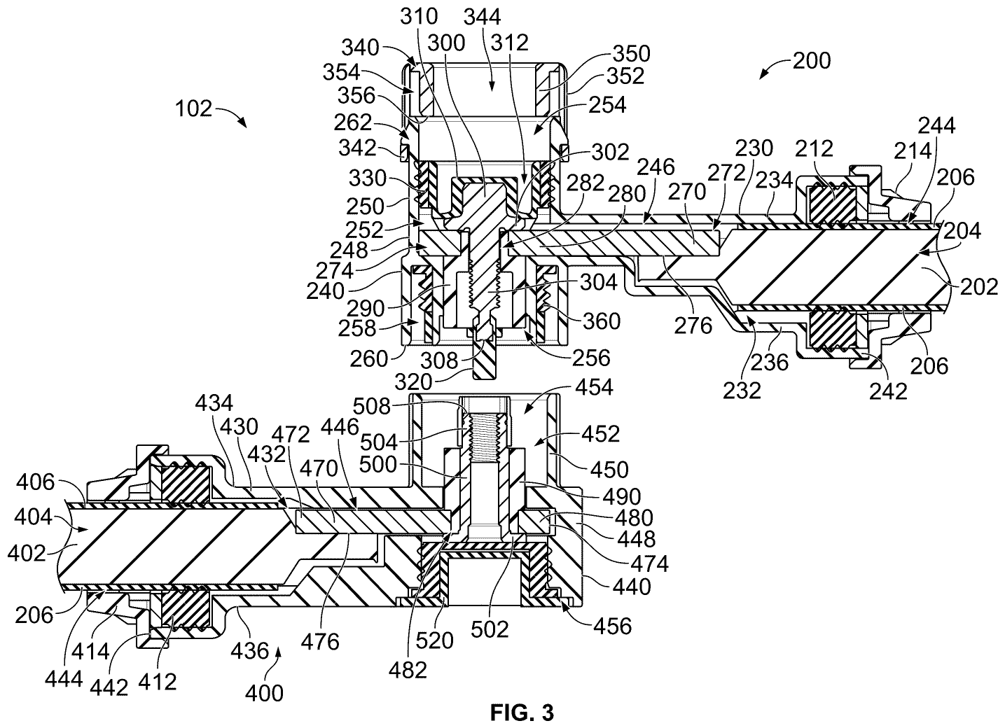

FIG. 3 is a cross-sectional view of the power harness 102 in accordance with an exemplary embodiment. FIG. 3 shows the first harness connector 200 and the second harness connector in an unmated state. The first harness connector 200 includes a power conductor 204, a housing 230, a power contact 270, a threaded bolt 300, and a bolt position assurance device 340. In the illustrated embodiment, the power conductor 204 is a power cable 202. However, in alternative embodiments, the power conductor 204 may be a busbar, a power terminal, or another type of power conductor.

The housing 230 receives the power cable 202, the power contact 270, the threaded bolt 300, and the bolt position assurance device 340. The housing 230 is configured to be mated with the second harness connector 400 (shown in FIG. 1). The threaded bolt 300 is used to mechanically connect the first harness connector 200 to the second harness connector 400. The power contact 270 is used to electrically connect the power cable 202 to the second harness connector 400. The bolt position assurance device 340 is configured to provide positional assurance of the threaded bolt 300 (for example, when assembled, assurance that the threaded bolt 300 is in a tightened position).

In an exemplary embodiment, the power cable 202 is a shielded and jacketed cable. The power cable 202 may be a solid core cable or may be a stranded or braided cable. The power cable 202 includes the center power conductor 204 and an insulator or jacket 206 surrounding the conductor 204. The power cable 202 may include a cable shield and/or an outer jacket surrounding the insulator 206. The insulator 206 is made from a dielectric or other insulating material to make the power cable 202 touch safe. The power conductor 204 may be manufactured from aluminum, copper, or an alloy thereof. The power conductor 204 is exposed at the terminating end of the power cable 202 for connection to the power contact 270. In the illustrated embodiment, the power cable 202 is a round power cable. However, in alternative embodiments, the power cable 202 may be generally rectangular in cross-section, such as having generally planar top and bottom surfaces. In alternative embodiments, the power conductor 204 may be a busbar, a metal plate, a terminal, or other structure rather than a power cable.

In an exemplary embodiment, a cable seal 212 is provided surrounding the power cable 202. The cable seal 212 may be sealed to the cable jacket 210. The cable seal 212 is configured to be sealed against the housing 230. The cable seal 212 may be a rubber material in various embodiments. Optionally, multiple cable seals 212 may be used to seal to the various components.

In an exemplary embodiment, a cable seal retainer 214 is provided at the end of the power cable 202 and is configured to be coupled to the housing 230. The cable seal retainer 214 may be secured to the housing 230 by a latch, clip, fastener or other securing element. The cable seal retainer 214 may provide strain relief for the power cable 202. The cable seal retainer 214 may hold or support the cable seal 212. The cable seal retainer 214 covers the opening in the housing 230 from impingement of moisture, such as from high pressure spray.

The housing 230 is manufactured from a dielectric material, such as a plastic material. Optionally, the housing 230 may be an injection molded part. In various embodiments, the housing 230 is a multi-piece housing. For example, the housing 230 may have an inner housing and an outer housing. The housing 230 may be clamshell type housing having an upper housing and a lower housing.

The housing 230 includes walls forming a chamber 232 that receives the power cable 202, the power contact 270, and the threaded bolt 300. In an exemplary embodiment, the housing 230 includes a top 234 and a bottom 236. The housing 230 includes sides 238 extending between a front 240 and a rear 242. The housing 230 includes a cable opening 244 at the rear 242 providing access to the chamber 232. The power cable 202 is received in the cable opening 244. In various embodiments, the cable opening 244 may be oriented generally horizontally. The cable seal retainer 214 may be plugged into the cable opening 244 and coupled to the housing 230 at the rear 242. The cable seal 212 may be sealed to the interior surface of the housing 230 at the cable opening 244.

In an exemplary embodiment, the housing 230 includes a contact channel 246 in the chamber 232 that receives the power contact 270. The contact channel 246 is aligned with the cable opening 244 to receive the power contact 270 with the power cable 202 from the cable opening 244. The contact channel 246 may receive the power contact 270 in a rear-to-front loading direction as the power contact 270 is loaded into the housing 230 from the rear 242. In the illustrated embodiment, the contact channel 246 is located at the front 240. The housing 230 includes walls 248 defining the contact channel 246. The walls 248 may form slots defining the contact channel 246, such as one or more horizontal slot and/or one or more vertical slots.

In an exemplary embodiment, the housing 230 includes a hub 250 having a bore 252 passing through the hub 250. The bore 252 is open to and defines a portion of the chamber 232. In the illustrated embodiment, the hub 250 is located at the front 240 of the housing 230. The hub 250 is aligned with the contact channel 246 and the power contact 270. The bolt position assurance device 340 is configured to be coupled to the hub 250. In various embodiments, the hub 250 is generally cylindrical. However, the hub 250 may have other shapes in alternative embodiments. The bore 252 passes through the housing 230, such as along a vertical axis between the top 234 and the bottom 236. In an exemplary embodiment, the power contact 270 is positioned in the housing 230 aligned with the bore 252, such as along the vertical axis, to receive the threaded bolt 300. The bore 252 includes an upper opening 254 and a lower opening 256. The threaded bolt 300 is received in the hub 250 and passes through the bore 252. For example, the threaded bolt 300 may pass through the upper opening 254 and/or the lower opening 256. In an exemplary embodiment, the contact channel 246 is aligned with the hub 250. The power contact 270 is received in the hub 250 when loaded into the contact channel 246.

The power contact 270 is a metal conductor, such as an aluminum or copper conductor. The power contact 270 may be an extruded metal contact in various embodiments. Alternatively, the power contact 270 may be hot forged or stamped and formed. The power contact 270 may be plated or coated in various embodiments. The power contact 270 may include a textured or knurled surface at the mating interface to improve electrical contact.

The power contact 270 extends between a terminating end 272 and a mating end 274. The terminating end 272 is configured to be terminated to the power conductor 204 of the power cable 202. The mating end 274 is configured to be electrically connected to the corresponding power contact of the second harness connector 400, such as through terminals. In an exemplary embodiment, the power contact 270 includes a weld pad 276 at the terminating end 272. The power conductor 204 is welded to the weld pad 276 at the terminating end 272. Other types of terminations may be used in alternative embodiments, such as a crimp barrel being crimped to the power conductor 204. The power contact 270 may be a multi-piece component, such as having the terminating end 272 discrete from and coupled to the mating end 274. For example, the components may be press-fit or welded together.

The power contact 270 includes a base plate 280 at the mating end 274. The base plate 280 may be planar. In various embodiments, the base plate 280 may be oriented horizontally. The base plate 280 includes an opening 282 therethrough, which may be approximately centered between the front and the rear and/or between the opposite sides of the base plate 280. The base plate 280 may define the weld pad 276, such as having the cable welded to the bottom of the base plate 280, such as being resistance welded to the base plate 280. The opening 282 may be drilled through the base plate 280 and the conductor of the cable.

In an exemplary embodiment, the power contact 270 includes a terminal 290 extending from the base plate 280. The terminal 290 is aligned with the opening 282, such as to receive the threaded bolt 300. The terminal 290 may be tubular and surround the threaded connector 500 and/or the threaded bolt 300. The terminal 290 may be press fit into the opening 282 and/or welded to the base plate 280. The terminal 290 is configured to be coupled to a corresponding terminal or base plate of the second harness connector 400 to create an electrical path between the first and second harness connectors 200, 400. The surface area of the edge of the terminal 290 may control the amount of power or current carrying capacity for the power contact 270.

The threaded bolt 300 is a threaded connector configured to be threadably coupled to a corresponding threaded connector of the second harness connector 400. The threaded bolt 300 includes a head 302 and a threaded shaft 304 extending from the head 302. The threaded shaft 304 includes threads at a distal end 308 of the threaded shaft 304. In an exemplary embodiment, the threaded bolt 300 is touch safe. For example, the threaded bolt 300 includes an insulating cover 310 on the head 302 and an insulating cap 320 extending from the distal end 308 of the threaded shaft 304.

The insulating cover 310 may be overmolded onto the head 302. Alternatively, the insulating cover 310 may be pre-formed and snap-fit, press-fit, adhered, or otherwise secured to the head 302. The insulating cover 310 covers the head 302 to prevent touching of the metal or conductive portion of the threaded bolt 300. In an exemplary embodiment, the insulating cover 310 includes drive features 312 for driving or rotating the threaded bolt 300. For example, the drive features 312 may be flat surfaces at the top of the insulating cover 310 that allow a socket wrench or other tool to rotate the threaded bolt 300 clockwise or counterclockwise for tightening or untightening the threaded bolt 300 during assembly with the second harness connector 400. Other types of drive features may be used in alternative embodiments, such as one or more slots to receive a screwdriver or other type of tool for tightening and untightening the threaded bolt 300.

The insulating cap 320 may be overmolded on to the threaded shaft 304. Alternatively, the insulating cap 320 may be pre-formed and snap-fit, press-fit, adhered, or otherwise secured to the distal end 308 of the threaded shaft 304. The insulating cap 320 covers the threaded shaft 304 to prevent touching of the metal or conductive portion of the threaded bolt 300.

In an exemplary embodiment, the first harness connector 200 includes a bolt seal 330 to seal between the threaded bolt 300 and the housing 230. In the illustrated embodiment, the bolt seal 330 is coupled to the insulating cover 310 at the head 302 of the threaded bolt 300. The outer surface of the bolt seal 330 is configured to be sealed to the housing 230, such as to the hub 250 when the threaded bolt 300 is received in the hub 250. For example, the bolt seal 330 may have a diameter equal to the diameter of the hub 250 at the upper opening 254.

In an exemplary embodiment, the bolt position assurance device 340 is coupled to the hub 250, such as at the top. The bolt position assurance device 340 is located above the head 302 of the threaded bolt 300. The bolt position assurance device 340 may define a bolt retainer to retain the threaded bolt 300 in the hub 250 of the housing 230. The bolt position assurance device 340 is coupled to the housing 230 outward of the threaded bolt 300, such as above the head 302 and the insulating cover 310.

The bolt position assurance device 340 includes latching elements 342 configured to be latchably coupled to the hub 250 to secure the bolt position assurance device 340 to the hub 250. For example, the hub 250 includes latching elements 262 configured to interface with the latching elements 342 to retain the bolt position assurance device 340 at one or more predetermined positions (for example, a pre-stage position and an assurance position). The latching elements 342 may be deflectable latches, catches, detents, or other types of latching elements. In an exemplary embodiment, the bolt position assurance device 340 includes an opening 344 to provide access to the threaded bolt 300, such as for engaging the drive features 312 to rotate the threaded bolt 300. However, in alternative embodiments, the bolt position assurance device 340 may be closed to prevent access to the threaded bolt 300.

In an exemplary embodiment, the bolt position assurance device 340 includes an inner wall 350 and an outer wall 352 with a pocket 354 therebetween. The inner and outer walls 350, 352 may be circumferential walls extending around the bolt position assurance device 340. The pocket 354 may be a circumferential groove located between the inner and outer walls 350, 352. The inner wall 350 extends along an interior of the hub 250. The outer wall 352 extends along an exterior of the hub 250. In an exemplary embodiment, the outer wall 352 includes the latching element(s) 342 to interface with the latching elements 262 of the hub 250 to position the bolt position assurance device 340 on the hub 250. The latching elements 262 may be deflectable latches, catches, detents, or other types of latching elements.

In an exemplary embodiment, the inner wall 350 includes a bottom edge 356 facing the threaded bolt 300. The bottom edge 356 is configured to interface with the threaded bolt 300. For example, the threaded bolt 300 may press upward against the bottom edge 356 and/or the bottom edge 356 may press downward against the threaded bolt 300. In an exemplary embodiment, the bottom edge 356 defines a retaining feature to retain the threaded bolt 300 in the housing 230. The bottom edge 356 is configured to be seated above the head 302 and the insulating cover 310 to prevent removal of the threaded bolt 300 through the opening 344. Other types of retaining features may be used in alternative embodiments.

In an exemplary embodiment, the first harness connector 200 includes a mating seal 360 coupled to the housing 230 at a mating end 260 of the housing 230. In the illustrated embodiment, the mating end 260 is provided at the bottom 236. The mating end 260 is located at the lower opening 256 of the hub 250. The mating end 260 is configured to be mated with the second harness connector 400. In an exemplary embodiment, the housing 230 includes a groove 258 at the bottom 236 surrounding the lower opening 256. The mating seal 360 is located in the groove 258. Optionally, the groove 258 may receive a portion of the housing of the second harness connector 400 to seal to the mating seal 360 in the groove 258. In alternative embodiments, the mating seal 360 may be located at the bottom and face downward to interface with the housing of the second harness connector 400.

The second harness connector 400 includes a power conductor 404, a housing 430, one or more power contacts 470, and one or more threaded connectors 500. The second harness connector 400 may include a pair of the power contacts 470 and corresponding threaded connectors 500 held within the same housing 430. Greater or fewer power contacts 470 and threaded connectors 500 may be provided in alternative embodiments. In an exemplary embodiment, the power conductor 404 is a power cable 402. However, in alternative embodiments, the power conductor 204 may be a busbar, a power terminal, or another type of power conductor.

In an exemplary embodiment, the power cable 402 is a shielded and jacketed cable. The power cable 402 may be a solid core cable or may be a stranded or braided cable. The power cable 402 includes the center power conductor 404 and an insulator or jacket 406 surrounding the conductor 404. The power cable 402 may include a cable shield surrounding the insulator and an outer jacket surrounding the insulator 406. The insulator 406 is made from a dielectric or other insulating material to make the power cable 402 touch safe. The power conductor 404 may be manufactured from aluminum, copper, or an alloy thereof. The power conductor 404 is exposed at the terminating end of the power cable 402 for connection to the power contact 470. In the illustrated embodiment, the power cable 402 is a round power cable. However, in alternative embodiments, the power cable 402 may be generally rectangular in cross-section, such as having generally planar top and bottom surfaces. In alternative embodiments, the power conductor 404 may be a busbar, a metal plate, a terminal, or other structure rather than a power cable.

In an exemplary embodiment, a cable seal 412 is provided surrounding the power cable 402. The cable seal 412 may be sealed to the cable jacket 410. The cable seal 412 is configured to be sealed against the housing 430. The cable seal 412 may be a rubber material in various embodiments. Optionally, multiple cable seals 412 may be used to seal to the various components.

In an exemplary embodiment, a cable seal retainer 414 is provided at the end of the power cable 402 and is configured to be coupled to the housing 430. The cable seal retainer 414 may be secured to the housing 430 by a latch, clip, fastener or other securing element. The cable seal retainer 414 may provide strain relief for the power cable 402. The cable seal retainer 414 may hold or support the cable seal 412. The cable seal retainer 414 covers the opening in the housing 430 from impingement of moisture, such as from high pressure spray.

The housing 430 receives the power cable 402, the power contact 470 and the threaded connector 500. The housing 430 is configured to be mated with the first harness connector 200 (shown in FIG. 2). The threaded connector 500 is used to mechanically connect the second harness connector 400 to the first harness connector 200. For example, the threaded connector 500 may be threadably coupled to the threaded bolt 300. The power contact 470 are used to electrically connect the power cable 402 to the first harness connector 200.

The housing 430 is manufactured from a dielectric material, such as a plastic material. Optionally, the housing 430 may be an injection molded part. In various embodiments, the housing 430 is a multi-piece housing. For example, the housing 430 may be clamshell type housing having an upper housing and a lower housing.

The housing 430 includes shroud walls 434 forming a chamber 432 that receives the power contacts 470 and the threaded connectors 500. The chamber 432 may receive the power conductors 402. In an exemplary embodiment, the housing 430 includes a top 436 and a bottom 438. The housing 430 includes sides extending between a front 440 and a rear 442. The housing 430 includes a cable opening 444 at the rear 442 providing access to the chamber 432. The power cable 402 is received in the cable opening 444. In various embodiments, the cable opening 444 may be oriented generally horizontally. The cable seal retainer 414 may be plugged into the cable opening 444 and coupled to the housing 430 at the rear 442. The cable seal 412 may be sealed to the interior surface of the housing 430 at the cable opening 444.

In an exemplary embodiment, the housing 430 includes a contact channel 446 in the chamber 432 that receives the power contact 470. The contact channel 446 is aligned with the cable opening 444 to receive the power contact 470 with the power cable 402 from the cable opening 444. The contact channel 446 may receive the power contact 470 in a rear-to-front loading direction as the power contact 470 is loaded into the housing 430 from the rear 442. In the illustrated embodiment, the contact channel 446 is located at the front 440. The housing 430 includes walls 448 defining the contact channel 446. The walls 448 may form slots defining the contact channel 446, such as one or more horizontal slot and/or one or more vertical slots.

In an exemplary embodiment, the housing 430 includes a hub 450 having a bore 452 passing through the hub 450 that receives the corresponding threaded connector 500. The bore 452 passes through the housing 430, such as along a vertical axis between the top 436 and the bottom 438. In an exemplary embodiment, the power contact 470 is positioned in the housing 430 aligned with the bore 452, such as along the vertical axis, to receive the threaded connector 500 and/or the threaded bolt 300.

The power contact 470 is a metal conductor, such as an aluminum or copper conductor. The power contact 470 may be an extruded metal contact in various embodiments. Alternatively, the power contact 470 may be hot forged or stamped and formed. The power contact 470 may be plated or coated in various embodiments.

The power contact 470 extends between a terminating end 472 and a mating end 474. The terminating end 472 is configured to be terminated to the power conductor 404. The mating end 474 is configured to be electrically connected with the corresponding power contact 270 of the first harness connector 200, such as through terminals between the power contacts 270, 470. The power contact 470 includes a weld pad 476 at the terminating end 472. The power conductor 404 is welded to the weld pad 476 at the terminating end 472. Other types of terminations may be used in alternative embodiments, such as a crimp barrel.

The power contact 470 includes a base plate 480 at the mating end 474. The base plate 480 may be planar. In various embodiments, the base plate 480 may be oriented horizontally. The base plate 480 includes an opening (not shown) therethrough, which may be approximately centered between the front and the rear and/or between the opposite sides of the base plate 480.

In an exemplary embodiment, the power contact 470 includes a terminal 490 extending from the base plate 480. The terminal 490 is aligned with the opening 482, such as to receive the threaded connector 500. The terminal 490 may be tubular and surround the threaded connector 500 and/or the threaded bolt 300. The terminal 490 may be press fit into the opening 482 and/or welded to the base plate 480. The terminal 490 is configured to be coupled to the terminal 290 to create an electrical path between the first and second harness connectors 200, 400. The surface area of the edge of the terminal 490 may control the amount of power or current carrying capacity for the power contact 470.

In an exemplary embodiment, the threaded connector 500 is a threaded insert. The threaded connector 500 includes a base 502 at a bottom of the threaded connector 500. The base 502 is configured to be coupled to the power contact 470, such as to the base plate 480. The threaded connector 500 includes a threaded tube 504. The threaded tube 504 includes internal threads inside the hollow bore of the threaded tube 504. The threaded tube 504 extends to a distal end 508. In an exemplary embodiment, the threaded connector 500 is touch safe. For example, the threaded connector 500 includes an insulating cap 520 at the distal end 508 of the threaded tube 504. The insulating cap 520 may be overmolded onto the threaded tube 504. Alternatively, the insulating cap 520 may be pre-formed and snap-fit, press-fit, adhered, or otherwise secured to the distal end 508 of the threaded tube 504. In alternative embodiments, the insulating cap 520 may be coupled to the housing 430, such as being received in the hub 450. The insulating cap 520 may be threadably coupled to the hub 450 or secured by adhesive. The insulating cap 520 covers the threaded tube 504 to prevent touching of the metal or conductive portion of the threaded connector 500.

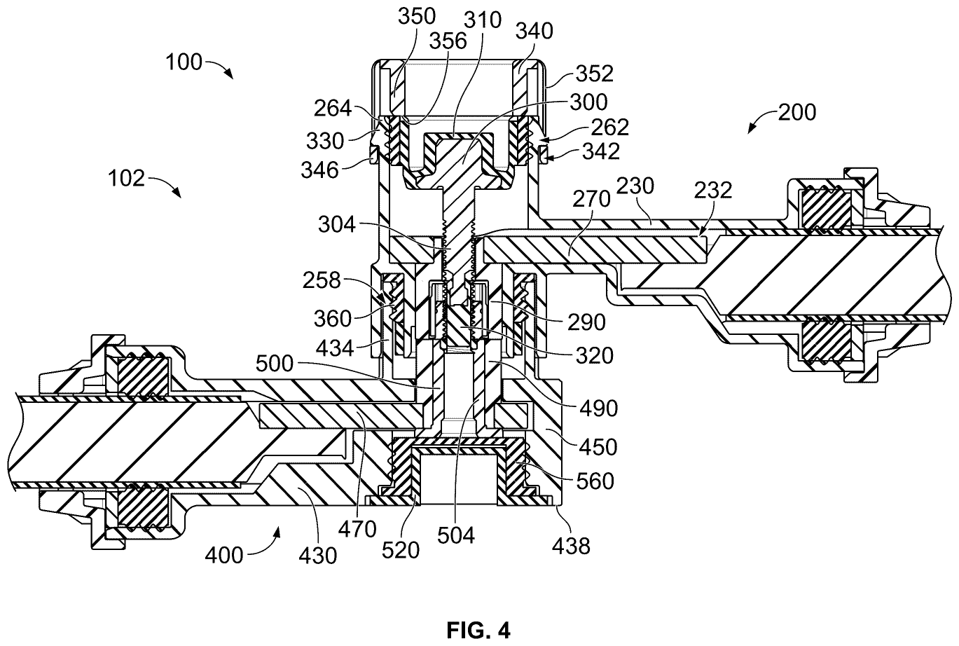

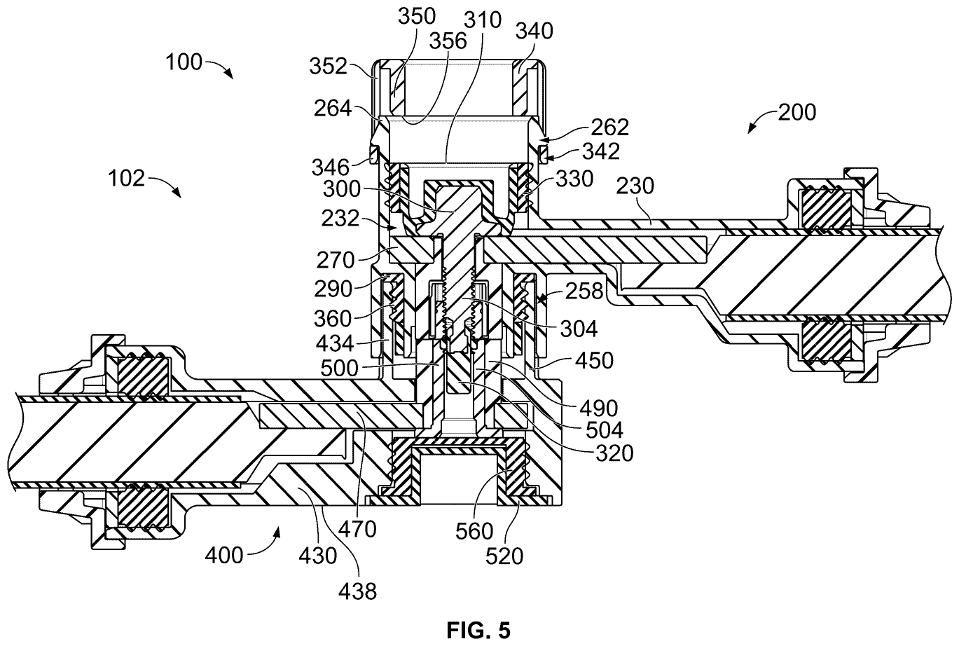

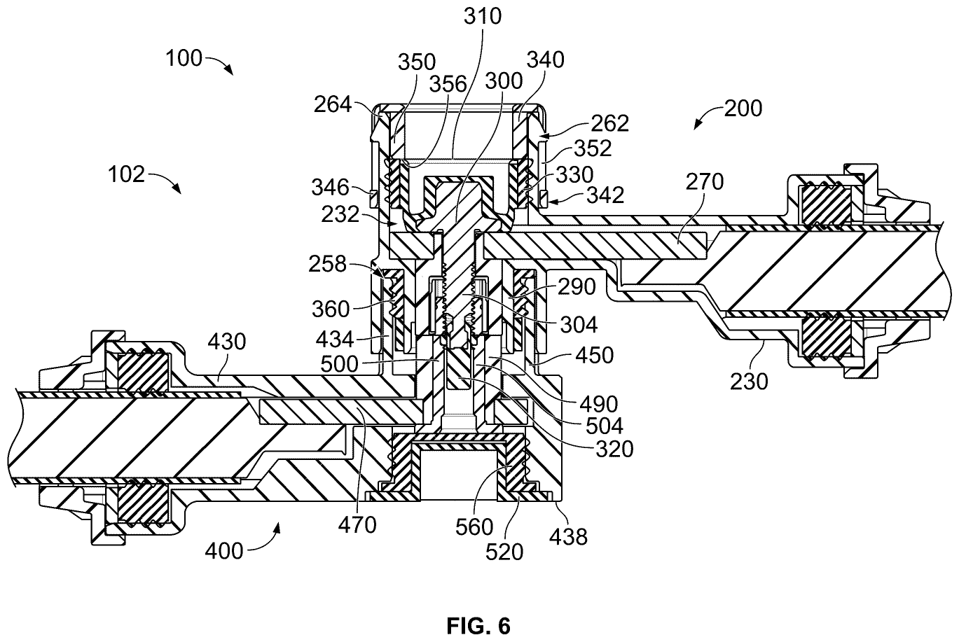

FIG. 4 is a cross-sectional view of the power system 100 showing the first harness connector 200 initially mated with the second harness connector 400 in a pre-stage position showing the threaded connectors unmated. FIG. 5 is a cross-sectional view of the power system 100 showing the first harness connector 200 mated with the second harness connector 400 showing the threaded connectors in a mated condition and showing the bolt position assurance device 340 in a pre-stage position. FIG. 6 is a cross-sectional view of the power system 100 showing the first harness connector 200 mated with the second harness connector 400 showing the threaded connectors in the mated condition and showing the bolt position assurance device 340 in an assurance position. The first and second harness connectors 200, 400 are mated in a mating direction along a mating axis. The mating axis may be a vertical axis.

During mating, the housings 230, 430 are aligned with each other. The shroud walls 434 are aligned with the groove 258 and plugged into the groove 258 when the first harness connector 200 is mated with the second harness connector 400. The shroud walls 434 are used to align the threaded connectors 300 (for example, threaded bolts) with the threaded connectors 500 (for example, threaded inserts). During mating, the threaded bolts 300 are plugged into the threaded connector 500. For example, the insulating cap 320 at the end of the threaded bolt 300 is plugged into the hollow bore of the threaded tube 504. When the threaded shaft 304 interfaces with the threaded tube 504, the threaded bolt 300 is rotated to tighten the threaded bolt 300 to the threaded connector 500.

When mated, the power system 100 is touch safe. The insulating cover 310 covers the top of the threaded bolt 300 such that no metal or conductive portion of the threaded bolt 300 may be touched from the exterior of the first harness connector 200. The housings 230, 430 cover or enclose the power contacts 270, 470 and the terminals 290, 490 such that no metal or conductive portion of the power contacts 270, 470 or the terminals 290, 490 may be touched from the exterior of the harness connectors 200, 400. In an exemplary embodiment, the insulating cover 310 covers the top end of the threaded bolt 300 making the first harness connector 200 touch safe. The portion of the threaded bolt 300 that is exposed at the exterior of the housing 230 is the insulating cap 320. No metal or conductive portion of the threaded bolt 300 is exposed. As such, the first harness connector 200 is touch safe in the unmated state. In the illustrated embodiment, the end of the threaded connector 500 may be recessed below the top or exterior of the hub 450 to avoid having metal exposed for inadvertent touching. Alternatively, a dielectric cap may be provided at the end to make the end touch safe. No metal or conductive portion of the threaded connector 500 is exposed. As such, the second harness connector 400 is touch safe in the unmated state.

During mating, the upper portion of the housing 430 of the second harness connector 400 is plugged into the lower portion of the housing 230 of the first harness connector 200. When mated, the power system 100 is sealed from the external environment. In the illustrated embodiment, the first harness connector 200 carries the mating seal 360 to interface with the shroud walls 434 of the second harness connector 400 during mating. As such, a sealed interface is provided between the first and second harness connectors 200, 400. In an exemplary embodiment, other openings in the housings 230, 430 are sealed, such as by the bolt seals 330. In an exemplary embodiment, a component seal 560 is provided at the bottom 438 of the housing 430. The component seal 560 is configured to be sealed to the second component 106.

The threaded bolt 300 and the threaded connector 500 are used to mechanically connect the first harness connector 200 to the second harness connector 400. For example, the threaded shaft 304 of the threaded bolt 300 is received in the bore of the threaded tube 504 of the threaded connector 500. The threaded bolt 300 is rotated to tighten the threaded shaft 304 in the threaded tube 504. As the threaded bolt 300 is tightened, the first harness connector 200 is electrically connected to the second harness connector 400. For example, the threaded connection between the threaded bolt 300 and the threaded connector 500 presses the power contact 270 into electrical connection with the power contact 470. For example, the terminal 290 is pressed into the terminal 490 such that the terminals 290, 490 are mated at the edges thereof to electrically connect the power contacts 270, 470. The threaded connectors 300, 500 maintain electrical connection between the terminals 290, 490 and the power contacts 270, 470. As such, an efficient power transmission path is created between the first and second harness connectors 200, 400. A compact, robust, sealed, vibration resistant, and touch safe electrical connection is made between the first and second harness connectors 200, 400.

During mating, when the first and second harness connectors 200, 400 are first mated (for example, the pre-stage mating position shown in FIG. 4), the threaded bolt 300 is pressed upward by the threaded connector 500 to an elevated position. The threaded bolt 300 may be pressed against the bolt position assurance device 340. The bolt position assurance device 340 retains the threaded bolt 300 in the hub 250 and prevents removal of the threaded bolt 300 from the chamber 232. The bolt position assurance device 340 is secured in the pre-stage position by the latching elements 262, 342. For example, the latching elements 262 may include pre-stage latching elements 264 proximate to the top of the hub 250 and the latching elements 342 may include pre-stage latching elements 346 proximate to the bottom of the outer wall 352 of the hub 340 (FIG. 2 shows the pre-stage latching elements 264, 346 engaged with each other). The pre-stage latching elements 264, 346 interface with each other to hold the bolt position assurance device 340 in the pre-stage position.

During assembly, the threaded bolt 300 is tightened to the mated or tightened position (FIG. 5). For example, the threaded bolt 300 may be tightened to a predetermined torque to physically press the terminals 290, 490 together in a mated condition to electrically connect the first and second harness connectors 200, 400. When tightened, the threaded bolt 300 is drawn downward toward the threaded connector 500, such as away from the bolt position assurance device 340. The bolt position assurance device 340 remains at the pre-stage position (FIG. 5) due to the interaction of the pre-stage latch elements 264, 346. Assembly is not complete at this point as the bolt position assurance device 340 needs to be actuated to the assurance position (FIG. 6).

The bolt position assurance device 340 operates as a visual indicator to the installer that the power harness 102 is properly assembled. For example, the installer is able to confirm proper assembly when the bolt position assurance device 340 is properly positioned in the assurance position (FIG. 6). After the threaded bolt 300 is tightened to the predetermined torque and is seated low in the hub 250, the bolt position assurance device 340 is able to move to the assurance position. For example, the installer is able to press the bolt position assurance device 340 downward toward the threaded bolt 300. The pre-stage latch elements 346 of the bolt position assurance device 340 are released from the pre-stage latch elements 264 of the hub 250 to move to the assurance position. The bolt position assurance device 340 may be pressed downward until the bottom edge 356 of the inner wall 350 bottoms out against the threaded bolt 300 (such as against the insulating cover 310). In an exemplary embodiment, the latching elements 262, 342 include assurance latching elements 266, 348 (shown in FIGS. 1 and 2) different from the pre-stage latching elements 264, 346 (FIG. 1 shows the assurance latching elements 266, 348 engaged with each other). The assurance latching elements 266 may be located proximate to the bottom of the hub 250 (for example, a further distance from the top edge of the hub than the pre-stage latching elements 264). The bolt position assurance device 340 includes the assurance latching elements 348 proximate to the bottom of the outer wall 352 of the hub 340. The assurance latching elements 266, 348 interface with each other to hold the bolt position assurance device 340 in the assurance position. In the assurance position (FIG. 6), the bolt position assurance device 340 provides visual assurance to the installer that the threaded bolt 300 is properly tightened (for example, to the predetermined torque). For example, if the threaded bolt 300 were only partially tightened, and thus not fully seated but instead at an elevated position, then the bolt position assurance device 340 would be unable to move all the way to the assurance position and the assurance latching elements 266, 348 would not engage. The bolt position assurance device 340 would be loose on the hub 250 rather than secured by the assurance latching elements 266, 348. The installer would be made aware of the improper installation and would need to further tighten the threaded bolt 300 to the predetermined torque.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A power harness connector comprising:
a housing having a chamber extending between a terminating end and a mating end configured to be mated with a mating harness connector, the housing including a hub at the mating end with a bore passing through the housing;
a power conductor extending from the chamber at the terminating end;
a power contact received in the chamber, the power contact having a terminating end terminated to the power conductor and a mating end aligned with the bore at the mating end of the housing, the power contact including a base plate having an opening;
a threaded bolt received in the hub and passing through the bore, the threaded bolt passing through the opening, the threaded bolt configured to be threadably coupled to a mating threaded connector of the mating harness connector to a tightened position; and
a bolt position assurance device coupled to the hub and movable between a pre-stage position and an assurance position, the bolt position assurance device assuring positioning of the threaded bolt in the hub at the tightened position in the assurance position.

2. The power harness connector of claim 1, wherein the bolt position assurance device is configured to move to the assurance position when the threaded bolt is in the tightened position.

3. The power harness connector of claim 1, wherein the threaded bolt is tightened to a predetermined torque at the tightened position, the bolt position assurance device only able to move to the assurance position when the threaded bolt is in the tightened position.

4. The power harness connector of claim 1, wherein the housing includes a pre-stage latch and an assurance latch, the bolt position assurance device coupled to the pre-stage latch in the pre-stage position, the bolt position assurance device coupled to the assurance latch in the assurance position.

5. The power harness connector of claim 1, wherein the threaded bolt is movable in a tightening direction toward the mating threaded connector when tightened to the threaded position, the bolt position assurance device movable in an actuation direction parallel to the tightening direction from the pre-stage position to the assurance position.

6. The power harness connector of claim 1, wherein the bolt position assurance device presses against the threaded bolt in the assurance position.

7. The power harness connector of claim 1, wherein the bolt position assurance device includes an opening, the threaded bolt being accessed through the opening to tighten the threaded bolt.

8. The power harness connector of claim 1, wherein the bolt position assurance device includes an inner wall and an outer wall with a pocket therebetween, the inner wall extending along an interior of the hub, the outer wall extending along an exterior of the hub, the inner wall including a bottom edge facing the threaded bolt.

9. The power harness connector of claim 8, wherein the outer wall includes a latching element configured to interface with a latching element of the hub to position the bolt position assurance device on the hub.

10. The power harness connector of claim 1, further comprising a housing seal at the mating end of the housing configured to interface with the mating harness connector to create a sealed interface with the mating harness connector.

11. The power harness connector of claim 1, wherein the threaded bolt includes a bolt seal configured to seal to the housing.

12. The power harness connector of claim 1, wherein the housing includes a contact channel, the power contact being loaded into the contact channel.

13. The power harness connector of claim 1, wherein the threaded connector includes an insulating cover at an exterior of the housing, the insulating cover positioned to make the threaded connector touch safe.

14. A power harness connector comprising:
a housing having a chamber extending between a terminating end and a mating end configured to be mated with a mating harness connector, the housing including a hub at the mating end with a bore passing through the housing;
a power conductor extending from the chamber at the terminating end;
a power contact received in the chamber, the power contact having a terminating end terminated to the power conductor and a mating end aligned with the bore at the mating end of the housing, the power contact including a base plate having an opening;
a threaded bolt received in the hub and passing through the bore, the threaded bolt passing through the opening, the threaded bolt configured to be threadably coupled to a mating threaded connector of the mating harness connector, the threaded bolt being rotated between an untightened position and a tightened position, the threaded bolt being tightened to a predetermined torque at the tightened position; and
a bolt position assurance device coupled to the hub and movable between a pre-stage position and an assurance position, the bolt position assurance device only able to move to the assurance position when the threaded bolt is in the tightened position, the bolt position assurance device assuring positioning of the threaded bolt in the hub at the tightened position in the assurance position.

15. The power harness connector of claim 14, wherein the bolt position assurance device is configured to move to the assurance position only when the threaded bolt is in the tightened position.

16. The power harness connector of claim 14, wherein the housing includes a pre-stage latch and an assurance latch, the bolt position assurance device coupled to the pre-stage latch in the pre-stage position, the bolt position assurance device coupled to the assurance latch in the assurance position.

17. A power harness comprising:
a first harness connector including a first housing having a first hub with a first bore passing through the first housing, the first harness connector including a first power conductor, the first harness connector including a first seal sealed to the first housing, the first harness connector including a threaded bolt received in the first hub and passing through the first bore, the threaded bolt including an insulating cover covering a head and an insulating cap at a distal end of a threaded shaft, the first harness connector including a bolt seal sealed between the threaded bolt and the first housing, the first harness connector including a first power contact received in the first hub, the first power contact having a terminating end terminated to the first power conductor and a mating end aligned with the first bore, the first power contact including a first base plate having a first opening receiving the threaded shaft of the threaded bolt;
a second harness connector coupled to the first harness connector, the second harness connector including a second housing having a second hub with a second bore passing through the second housing, the second harness connector including a second power conductor, the second harness connector including a second seal sealed to the second housing, the second harness connector including a socket insert received in the second hub and passing through the second bore, the socket insert including a threaded bore threadably coupled to the threaded bolt of the first harness connector, the socket insert including an insulating cap at a distal end of socket insert, the second harness connector including a second power contact having a terminating end terminated to the second power conductor and a mating end aligned with the second bore, the second power contact including a second base plate having a second opening receiving the threaded insert;
a mating seal sealed between the first housing and the second housing at a mating interface between the first and second harness connectors; and
a bolt position assurance device coupled to the first hub and movable between a pre-stage position and an assurance position;
wherein the threaded bolt is threadably coupled to the threaded insert to a tightened position, the bolt position assurance device assuring positioning of the threaded bolt in the first hub at the tightened position in the assurance position.

18. The power harness of claim 17, wherein the first power conductor is a power cable terminated to the terminating end of the first power contact, the power cable extending from the first connector housing, the second power conductor being one of a second power cable or a busbar connected to an electrical device.

19. The power harness of claim 17, wherein the first and second harness connectors are both touch-proof both before and after coupling.

20. The power harness of claim 17, wherein the first and second harness connectors are completely sealed when mated.
